(19) United States
(12) Patent Application Publication
(10) Pub. No.: US 2020/0102879 A1
(43) Pub. Date: Apr. 2, 2020

(54) MARINE OUTBOARD MOTOR WITH TURBOCHARGER LUBRICATION

(71) Applicant: COX POWERTRAIN LIMITED, Shoreham-By-Sea (GB)

(72) Inventor: Julian WEST, Shoreham-By-Sea (GB)

(21) Appl. No.: 16/572,117

(22) Filed: Sep. 16, 2019

(30) Foreign Application Priority Data
Sep. 28, 2018 (GB) 1815933.5

(51) Int. Cl. F01P 3/20; F02B 39/00; F01M 5/00

(52) U.S. Cl. CPC F01P 3/202; F01P 2003/006; F01M 5/005; F02B 39/005

(57) ABSTRACT

A marine outboard motor is provided with an internal combustion engine comprising an engine block having an engine lubrication fluid circuit, at least one turbocharger having at least one lubricating fluid inlet and at least one lubricating fluid outlet, and a turbocharger lubrication system configured to lubricate the at least one turbocharger. The turbocharger lubrication system includes a feed path extending from the engine lubrication fluid circuit to the at least one lubricating fluid inlet, and a drain path extending from the at least one lubricating fluid outlet to the engine block. The drain path includes at least one drain tank configured to receive lubricating fluid drained from the at least one lubricating fluid outlet, and a scavenge pump configured to return lubricating fluid from the at least one drain tank back to the engine lubrication fluid circuit.

### TECHNICAL FIELD

The present invention relates to a marine outboard motor with a turbocharger and a lubrication system for lubricating the turbocharger. While this application relates to marine outboard motors, the teachings may also be applicable to any other internal combustion engine.

### BACKGROUND

At present, the outboard engine market is dominated by petrol engines. Petrol engines are typically lighter than their diesel equivalents. However, a range of users, from military operators to super-yacht owners, have begun to favour diesel outboard motors because of the improved safety of diesel fuel, due to its lower volatility, and to allow fuel compatibility with the mother ship. Furthermore, diesel is a more economical fuel source with a more readily accessible infrastructure for marine applications.

To meet current emissions standards, modern diesel engines for automotive applications typically use sophisticated charge systems, such as direct cylinder injection and turbocharging, to improve power output and efficiency relative to naturally aspirated diesel engines. With direct injection, pressurised fuel is injected directly into the combustion chambers. This makes it possible to achieve more complete combustion resulting in better engine economy and emission control.

Turbocharging is commonly known to produce higher power outputs, lower emission levels, and improved efficiency compared to normally aspirated diesel engines. In a turbocharged engine, pressurised intake air is introduced into the intake manifold to improve efficiency and power output by forcing extra amounts of air into the combustion chambers.

During operation, turbochargers must be provided with an adequate flow of lubricating fluid or “lubricant”, such as oil, to ensure smooth running of their moving parts and thereby avoid turbocharger failure. A clear lubricant drainage path from the turbocharger is important to ensure sufficient lubricant flow through the turbocharger. Restriction of the lubricant drain path will result in a reduction in lubricant flow rate through the turbocharger, which can lead to an increase in the lubricant temperature in the turbocharger. If the lubricant temperature in the turbocharger is raised high enough, this can lead to carbonisation of the lubricant and to subsequent failure of bearing surfaces due to excessive friction. The risk of this occurring can be reduced by mounting the turbochargers in such a way as to allow an unimpeded flow of lubricant from the turbocharger drains in all operating conditions.

However, with marine outboard motors, the available space under the cowl can be extremely limited. This means that it may be necessary to position the turbocharger according to the available space under the cowl, rather than to optimise lubricant drainage from the turbocharger. Furthermore, marine outboard motors are subject to extreme operating angles imposed by both dynamic sea states as well as situations in which the outboard motor must operate with high degrees of tilt or trim. This can lead to the lubricant drain orifices of the turbocharger being submerged in lubricant in the sump in certain operating conditions, particularly where the turbocharger must be mounted lower down on the vertical axis of the engine due to packaging restraints. The combination of these factors can lead to inadequate lubricant flow through the turbocharger during operation.

The present invention seeks to provide an improved marine outboard motor which overcomes or mitigates one or more problems associated with the prior art.

### SUMMARY OF THE INVENTION

According to a first aspect of the present invention, there is provided a marine outboard motor having an internal combustion engine, the internal combustion engine comprising: an engine block having an engine lubrication fluid circuit; at least one turbocharger having at least one lubricating fluid inlet and at least one lubricating fluid outlet; and a turbocharger lubrication system configured to lubricate the at least one turbocharger, the turbocharger lubrication system comprising a feed path extending from the engine lubrication fluid circuit to the at least one lubricating fluid inlet, and a drain path extending from the at least one lubricating fluid outlet to the engine block, wherein the drain path comprises at least one drain tank configured to receive lubricating fluid drained from the at least one lubricating fluid outlet, and a scavenge pump configured to return lubricating fluid from the at least one drain tank back to the engine lubrication fluid circuit.

With this arrangement, lubricant is readily drained from the turbocharger during operation and adequate lubricating fluid flow through the turbocharger can be more readily maintained, even when the outboard motor is subjected to extreme operating angles. This is in contrast to conventional arrangements in which the turbocharger is drained straight back into the sump and in which the lubricating fluid outlet orifices can be occluded by lubricating fluid in the sump in certain operating conditions. Additionally, in conventional arrangements, lubricating fluid can remain in the turbocharger following engine shutdown when the fluid seals are generally not energised. This presents an increased risk of lubricating fluid egress into one or both of the turbine and compressor housings following engine shutdown, resulting in additional emissions on start-up and elevated lubricant consumption. This can be avoided with the claimed arrangement, since lubricating fluid can be drained into the drain tank to drain the turbocharger of lubricating fluid even following engine shutdown.

Furthermore, the drain tank can also reduce the risk of backflow to the turbocharger of lubricating fluid from the drain path following engine shutdown by providing a volume for this lubricating fluid to drain into. The provision of the drain tank can also avoid the need for the scavenge pump to have its own backflow prevention means to prevent lubricating fluid from entering the turbochargers from the scavenge pump outlet line. This can facilitate reduced complexity and/or weight of the scavenge pump.

The at least one turbocharger may be mounted in any suitable position relative to the engine block. For example, the at least one turbocharger may be positioned above or along a horizontal centre line of the engine block. In certain embodiments, the at least one turbocharger is positioned below a horizontal centre line of the engine block. Where the at least one turbocharger comprises a plurality of turbochargers, preferably all of the plurality of turbochargers are positioned below a horizontal centre line of the engine block.

The at least one drain tank may be integral with a housing of the at least one turbocharger. The at least one drain tank may be adjacent to the at least one turbocharger. In certain embodiments, the at least one drain tank is remote from the at least one turbocharger. With this arrangement, the vertical distance between the at least one turbocharger and the at least one drain tank can be more easily increased despite the limited space available under a cowl of the marine outboard motor. The increased vertical distance can increase the efficiency with which lubricating fluid is drained from the at least one turbocharger. In such embodiments, the at least one drain tank may be connected to the at least one lubricating fluid outlet by a lubricating fluid drain duct, such as a hose.

The at least one drain tank is preferably positioned towards the lowest point of the engine lubrication fluid circuit. In certain embodiments, the at least one drain tank is mounted below a lowest point of the engine lubrication fluid circuit. In other words, the at least one drain tank may be lower than the lowest point of the engine lubrication fluid circuit.

The scavenge pump is preferably positioned towards the lowest point of the engine lubrication fluid circuit. In certain embodiments, the scavenge pump is mounted below a lowest point of the engine lubrication fluid circuit. In other words, the scavenge pump may be lower than the lowest point of the engine lubrication fluid circuit.

The engine lubrication fluid circuit may be a sump-less fluid circuit. In preferred embodiments, the engine lubrication fluid circuit comprises a sump. The drain path may extend to the sump. Preferably, the drain path extends to a part of the engine block which is remote from the sump.

The engine block preferably comprises a cam cover. Preferably, the drain path extends to the cam cover so that, during use, the scavenge pump returns lubricating fluid to the engine lubrication fluid circuit via the cam cover.

The scavenge pump may be an electric pump.

The scavenge pump may be a mechanical pump. The scavenge pump may be a mechanical pump which is configured to be driven by a shaft of the internal combustion engine.

The scavenge pump may be a mechanical pump which is configured to be driven by a camshaft of the internal combustion engine.

The at least one turbocharger may comprise a single turbocharger. In certain embodiments, the at least one turbocharger comprises a plurality of turbochargers. The at least one drain tank may be configured to receive lubricating fluid drained from the at least one lubricating fluid outlet of each of the plurality of turbochargers.

Where the at least one turbocharger comprises a single turbocharger, the at least one lubricating fluid outlet may comprise a single lubricating fluid outlet. Alternatively, the single turbocharger may comprise a plurality of lubricating fluid outlets. Where the at least one turbocharger comprises a plurality of turbochargers, each turbocharger may comprise a single lubricating fluid outlet. Alternatively, one or more of the plurality of turbochargers may comprise a plurality of lubricating fluid outlets.

Where the at least one turbocharger comprises a single turbocharger, the at least one lubricating fluid inlet may comprise a single lubricating fluid inlet. Alternatively, the single turbocharger may comprise a plurality of lubricating fluid inlets. Where the at least one turbocharger comprises a plurality of turbochargers, each turbocharger may comprise a single lubricating fluid inlet. Alternatively, one or more of the plurality of turbochargers may comprise a plurality of lubricating fluid inlets.

The at least one drain tank may comprise a single drain tank. Where the at least one turbocharger comprises a plurality of turbochargers, the single drain tank may be configured to receive lubricating fluid drained from the at least one lubricating fluid outlet of each of the plurality of turbochargers. In certain embodiments, the at least one turbocharger comprises a plurality of turbochargers and the at least one drain tank comprises a plurality of drain tanks configured to receive lubricating fluid drained from the at least one lubricating fluid outlet of each of the plurality of turbochargers.

The engine block may comprise a single cylinder. Preferably, the engine block comprises a plurality of cylinders.

As used herein, the term “engine block” refers to a solid structure in which at least one cylinder of the engine is provided. The term may refer to the combination of a cylinder block with a cylinder head and crankcase, or to the cylinder block only. The engine block may be formed from a single engine block casting. The engine block may be formed from a plurality of separate engine block castings which are connected together, for example using bolts.

The engine block may comprise a single cylinder bank.

The engine block may comprise a first cylinder bank and a second cylinder bank. The first and second cylinder banks may be arranged in a V configuration.

The engine block may comprise three cylinder banks. The three cylinder banks may be arranged in a broad arrow configuration. The engine block may comprise four cylinder banks. The four cylinder banks may be arranged in a W or double-V configuration.

Where the engine block comprises a plurality of cylinder banks, the at least one turbocharger may comprise a single turbocharger for all of the cylinder banks. Preferably, the at least one turbocharger comprises a plurality of turbochargers, each of which is associated with one of the plurality of cylinder banks.

Where the engine block comprises first and second cylinder banks, the at least one turbocharger may comprise a single turbocharger for both of the first and second cylinder banks. Preferably, the at least one turbocharger comprises a first turbocharger mounted on the first cylinder bank and a second turbocharger mounted on the second cylinder bank. The first and second cylinder banks may be arranged in a V configuration with the first and second turbochargers being located on the outer sides of the V which is formed by first and second cylinder banks.

Where the at least one turbocharger comprises a first turbocharger mounted on the first cylinder bank and a second turbocharger mounted on the second cylinder bank, the at least one drain tank may comprise a single drain tank configured to receive lubricating fluid drained from the at least one lubricating fluid outlet of the first turbocharger and from the at least one lubricating fluid outlet of the second turbocharger. In preferred embodiments, the at least one drain tank comprises a first drain tank configured to receive lubricating fluid drained from the at least one lubricating fluid outlet of the first turbocharger, and a second drain tank configured to receive lubricating fluid drained from the at least one lubricating fluid outlet of the second turbocharger.

Where the at least one drain tank comprises a plurality of drain tanks, the scavenge pump may comprise a plurality of scavenge pumps, each of which may be configured to return lubricating fluid from one or more of the plurality of drain tanks. In certain embodiments where the at least one drain tank comprises a first drain tank configured to receive lubricating fluid drained from the at least one lubricating fluid outlet of the first turbocharger, and a second drain tank configured to receive lubricating fluid drained from the at least one lubricating fluid outlet of the second turbocharger, the scavenge pump is a single scavenge pump configured to return lubricating fluid from both of the first and second drain tanks back to the engine lubrication fluid circuit.

The internal combustion engine may be arranged in any suitable orientation. Preferably, the internal combustion engine is a vertical axis internal combustion engine. In such an engine, the internal combustion engine comprises a crankshaft which is mounted vertically in the engine.

The internal combustion engine may be a petrol engine. Preferably, the internal combustion engine is a diesel engine.

According to a second aspect of the present invention, there is provided a marine vessel comprising the marine outboard motor of the first aspect.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Further features and advantages of the present invention will be further described below, by way of example only, with reference to the accompanying drawings in which:

FIG. 1 is a schematic side view of a light marine vessel provided with a marine outboard motor;

FIG. 2A shows a schematic representation of a marine outboard motor in its tilted position;

FIGS. 2B to 2D show various trimming positions of the marine outboard motor and the corresponding orientation of the marine vessel within a body of water;

FIG. 3 shows a schematic cross-section of a marine outboard motor according to an embodiment of the present invention;

FIG. 4 is a flowchart illustrating lubricating fluid flow around the internal combustion engine of the marine outboard motor of FIG. 3

FIG. 5 shows a left side view of the internal combustion engine of the marine outboard motor of FIG. 3;

FIG. 6 shows a right side view of the internal combustion engine of FIG. 5; and

FIG. 7 is a rear view of the internal combustion engine of FIGS. 5 and 6.

### DETAILED DESCRIPTION

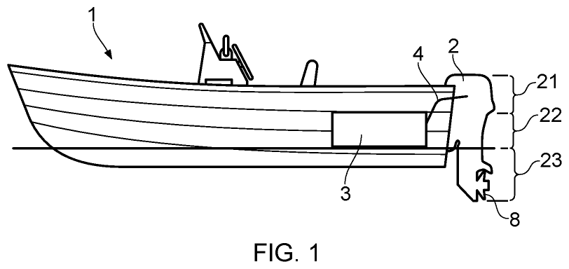

Referring firstly to FIG. 1, there is shown a schematic side view of a marine vessel 1 with a marine outboard motor 2. The marine vessel 1 may be any kind of vessel suitable for use with a marine outboard motor, such as a tender or a scuba-diving boat. The marine outboard motor 2 shown in FIG. 1 is attached to the stern of the vessel 1. The marine outboard motor 2 is connected to a fuel tank 3, usually received within the hull of the marine vessel 1. Fuel from the reservoir or tank 3 is provided to the marine outboard motor 2 via a fuel line 4. Fuel line 4 may be a representation for a collective arrangement of one or more filters, low pressure pumps and separator tanks (for preventing water from entering the marine outboard motor 2) arranged between the fuel tank 3 and the marine outboard motor 2.

As will be described in more detail below, the marine outboard motor 2 is generally divided into three sections, an upper-section 21, a mid-section 22, and a lower-section 23. The mid-section 22 and lower-section 23 are often collectively known as the leg section, and the leg houses the exhaust system. A propeller 8 is rotatably arranged on a propeller shaft at the lower-section 23, also known as the gearbox, of the marine outboard motor 2. Of course, in operation, the propeller 8 is at least partly submerged in water and may be operated at varying rotational speeds to propel the marine vessel 1.

Typically, the marine outboard motor 2 is pivotally connected to the stern of the marine vessel 1 by means of a pivot pin. Pivotal movement about the pivot pin enables the operator to tilt and trim the marine outboard motor 2 about a horizontal axis in a manner known in the art. Further, as is well known in the art, the marine outboard motor 2 is also pivotally mounted to the stern of the marine vessel 1 so as to be able to pivot, about a generally upright axis, to steer the marine vessel 1.

Tilting is a movement that raises the marine outboard motor 2 far enough so that the entire marine outboard motor 2 is able to be raised completely out of the water. Tilting the marine outboard motor 2 may be performed with the marine outboard motor 2 turned off or in neutral. However, in some instances, the marine outboard motor 2 may be configured to allow limited running of the marine outboard motor 2 in the tilt range so as to enable operation in shallow waters. Marine engine assemblies are therefore predominantly operated with a longitudinal axis of the leg in a substantially vertical direction. As such, a crankshaft of an engine of the marine outboard motor 2 which is substantially parallel to a longitudinal axis of the leg of the marine outboard motor 2 will be generally oriented in a vertical orientation during normal operation of the marine outboard motor 2, but may also be oriented in a non-vertical direction under certain operating conditions, in particular when operated on a vessel in shallow water. A crankshaft of a marine outboard motor 2 which is oriented substantially parallel to a longitudinal axis of the leg of the engine assembly can also be termed a vertical crankshaft arrangement. A crankshaft of a marine outboard motor 2 which is oriented substantially perpendicular to a longitudinal axis of the leg of the engine assembly can also be termed a horizontal crankshaft arrangement.

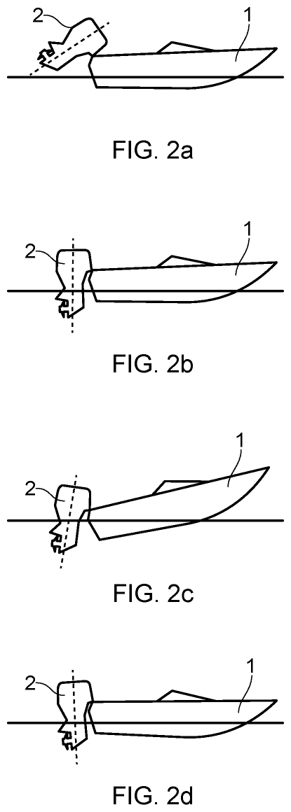

As mentioned previously, to work properly, the lower-section 23 of the marine outboard motor 2 needs to extend into the water. In extremely shallow waters, however, or when launching a vessel off a trailer, the lower-section 23 of the marine outboard motor 2 could drag on the seabed or boat ramp if in the tilted-down position. Tilting the marine outboard motor 2 into its tilted-up position, such as the position shown in FIG. 2A, prevents such damage to the lower-section 23 and the propeller 8.

By contrast, trimming is the mechanism that moves the marine outboard motor 2 over a smaller range from a fully-down position to a few degrees upwards, as shown in the three examples of FIGS. 2B to 2D. Trimming helps to direct the thrust of the propeller 8 in a direction that will provide the best combination of fuel efficiency, acceleration and high speed operation of the marine vessel 1.

When the vessel 1 is on a plane (i.e. when the weight of the vessel 1 is predominantly supported by hydrodynamic lift, rather than hydrostatic lift), a bow-up configuration results in less drag, greater stability and efficiency. This is generally the case when the keel line of the boat or marine vessel 1 is up about three to five degrees, such as shown in FIG. 2B for example.

Too much trim-out puts the bow of the vessel 1 too high in the water, such as the position shown in FIG. 2C. Performance and economy, in this configuration, are decreased because the hull of the vessel 1 is pushing the water and the result is more air drag. Excessive trimming-out can also cause the propeller to ventilate, resulting in further reduced performance. In even more severe cases, the vessel 1 may hop in the water, which could throw the operator and passengers overboard.

Trimming-in will cause the bow of the vessel 1 to be down, which will help accelerate from a standing start. Too much trim-in, shown in FIG. 2D, causes the vessel 1 to “plough” through the water, decreasing fuel economy and making it hard to increase speed. At high speeds, trimming-in may even result in instability of the vessel 1.

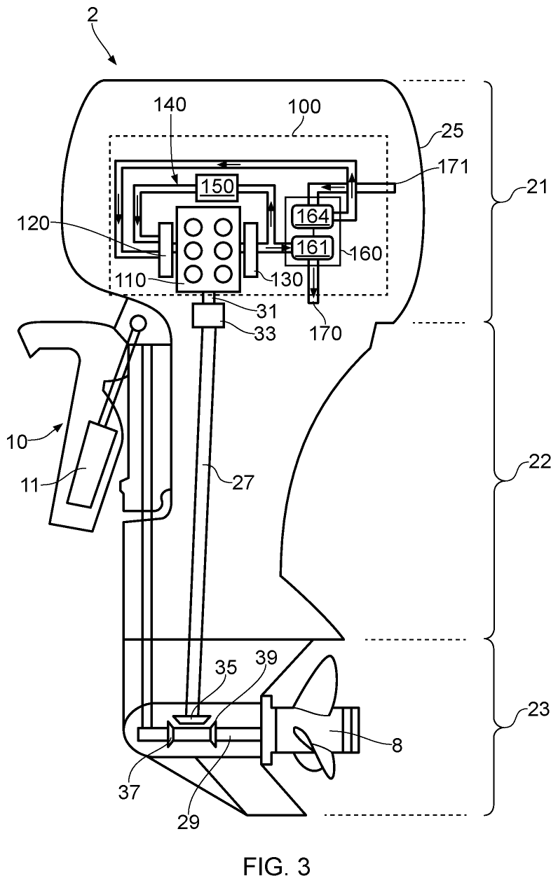

Turning to FIG. 3, there is shown a schematic cross-section of an outboard motor 2 according to an embodiment of the present invention. The outboard motor 2 comprises a tilt and trim mechanism 10 for performing the aforementioned tilting and trimming operations. In this embodiment, the tilt and trim mechanism 10 includes a hydraulic actuator 11 that can be operated to tilt and trim the outboard motor 2 via an electric control system. Alternatively, it is also feasible to provide a manual tilt and trim mechanism, in which the operator pivots the outboard motor 2 by hand rather than using a hydraulic actuator.

As mentioned above, the outboard motor 2 is generally divided into three sections. An upper-section 21, also known as the powerhead, includes an internal combustion engine 100 for powering the marine vessel 1. A cowling 25 is disposed around the engine 100.

Adjacent to, and extending below, the upper-section 21 or powerhead, there is provided a mid-section 22 and a lower section 23. The lower-section 23 extends adjacent to and below the mid-section 22, and the mid-section 22 connects the upper-section 21 to the lower-section 23. The mid-section 22 houses a drive shaft 27 which extends between the combustion engine 100 and the propeller shaft 29 and is connected to a crankshaft 31 of the combustion engine via a floating connector 33 (e.g. a splined connection). At the lower end of the drive shaft 27, a gear box/transmission is provided that supplies the rotational energy of the drive shaft 27 to the propeller 8 in a horizontal direction. In more detail, the bottom end of the drive shaft 27 may include a bevel gear 35 connected to a pair of bevel gears 37, 39 that are rotationally connected to the propeller shaft 29 of the propeller 8.

The mid-section 22 and lower-section 23 form an exhaust system, which defines an exhaust gas flow path for transporting exhaust gases from an exhaust gas outlet 170 of the internal combustion engine 100 and out of the outboard motor 2.

As shown schematically in FIG. 3, the internal combustion engine 100 includes an engine block 110, an air intake manifold 120 for delivering a flow of air to the cylinders in the engine block, and an exhaust manifold 130 configured to direct a flow of exhaust gas from the cylinders. In this example, the engine 100 further includes an optional exhaust gas recirculation (EGR) system 140 configured to recirculate a portion of the flow of exhaust gas from the exhaust manifold 130 to the air intake manifold 120. The EGR system includes a heat exchanger 150, or “EGR cooler”, for cooling recirculated exhaust gas. The internal combustion engine 100 is turbocharged and so further includes a turbocharger 160 connected to the exhaust manifold 130 and to the air intake manifold 120. In use, exhaust gases are expelled from each cylinder in the engine block 110 and are directed away from the engine block 110 by the exhaust manifold 130. Where the engine includes an EGR system 140, a portion of the exhaust gases are diverted to the heat exchanger 150. The remaining exhaust gases are delivered from the exhaust manifold 130 to a turbine housing 161 of the turbocharger 160 where they are directed through the turbine before exiting the turbocharger 160 and the engine 100 via the engine exhaust outlet 170. The compressor housing 164 of the turbocharger, which is driven by the spinning turbine, draws in ambient air through an air intake 171 and delivers a flow of pressurised intake air to the air intake manifold 120. The engine 100 also includes an engine lubrication fluid circuit, to lubricate moving components in the engine block, and a turbocharger lubrication system (not shown in FIG. 3).

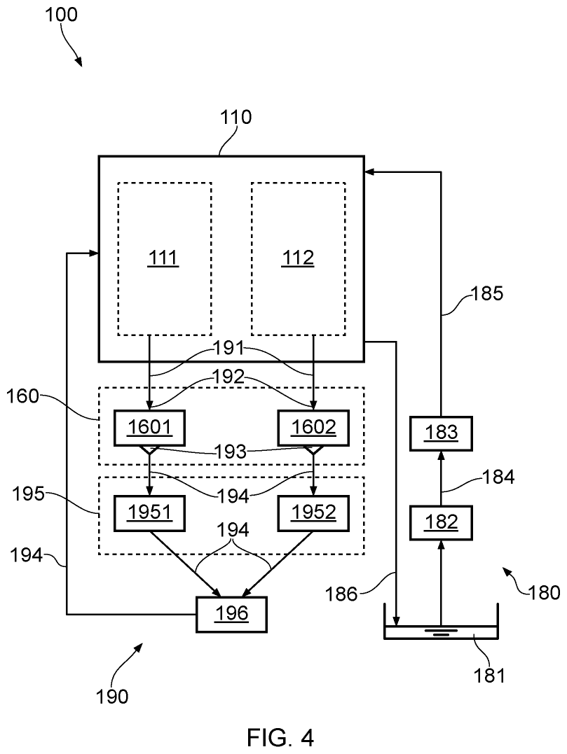

FIG. 4 is a flowchart showing a schematic illustration of the flow of lubricating fluid through both the engine lubrication fluid circuit 180 and the turbocharger lubrication system 190 of the internal combustion engine 100. In this example, the engine block 110 comprises first and second cylinder banks 111, 112 arranged in a V configuration and each housing a plurality of cylinders and movable pistons forming combustion chambers within the engine block 110, while the at least one turbocharger 160 comprises a first turbocharger 1601 mounted on the first cylinder bank 111 and a second turbocharger 1602 mounted on the second cylinder bank 112. However, it will be understood that any other arrangement, such as an in-line arrangement, could alternatively be utilised. In any such example, the engine may comprise one or more of each of the intake manifold 120, exhaust manifold 130, EGR system 140, EGR cooler 150, and turbocharger 160.

The engine lubrication fluid circuit 180 comprises a lubricant supply in the form of a sump 181, a lubricant pump 182, a lubricant filter 183, a supply line 184, a lubricant line 185, and a return line 186. The engine lubrication fluid circuit 180 may also include a heat exchanger, such as an oil to water heat exchanger (not shown). The lubricant pump 182 may be an electrical pump, or a mechanical pump which is driven by a shaft of the engine 100, for example by the drive shaft or the crank shaft.

During operation of the engine 100, the lubricant pump 182 draws lubricating fluid, or “lubricant”, such as oil, from the sump 181 and delivers it through the supply line 184 to the lubricant filter 183 before delivering the lubricant to one or more lubricant galleries positioned in the engine block 110. The lubricant passes through the engine block 110 and lubricates one or more moving components of the engine before draining back to the sump 181 through one or more return passages or return pipes 186.

The turbocharger lubrication system 190 comprises a feed path 191 extending from the engine lubrication fluid circuit to at least one lubricating fluid inlet of each of the turbochargers 1601, 1602, and a drain path 194 extending from at least one lubricating fluid outlet of each of the turbochargers 1601, 1602 to the engine block 110. The drain path includes at least one drain tank 195 configured to receive lubricating fluid drained from the at least one lubricating fluid outlet of the turbochargers. The drain path 194 also includes a scavenge pump 196 configured to return lubricating fluid from the drain tank 195 back to the engine lubrication fluid circuit 180. In this example, the engine includes a first drain tank 1951 configured to receive lubricating fluid drained from the at least one lubricating fluid outlet of the first turbocharger 1601 and a second drain tank 1952 configured to receive lubricating fluid drained from the at least one lubricating fluid outlet of the second turbocharger 1602. In other examples, a single drain tank may be provided for all turbochargers, or a plurality of drain tanks may be provided for any single turbocharger. In this example, the drain path 194 returns lubricating fluid to the engine lubrication system 180 via a cam cover of the engine. It will be understood that the feed path 191 and the drain path 192 may respectively extend from and to any suitable part of the engine in order to receive and return lubricating fluid from and to the engine lubrication system 180.

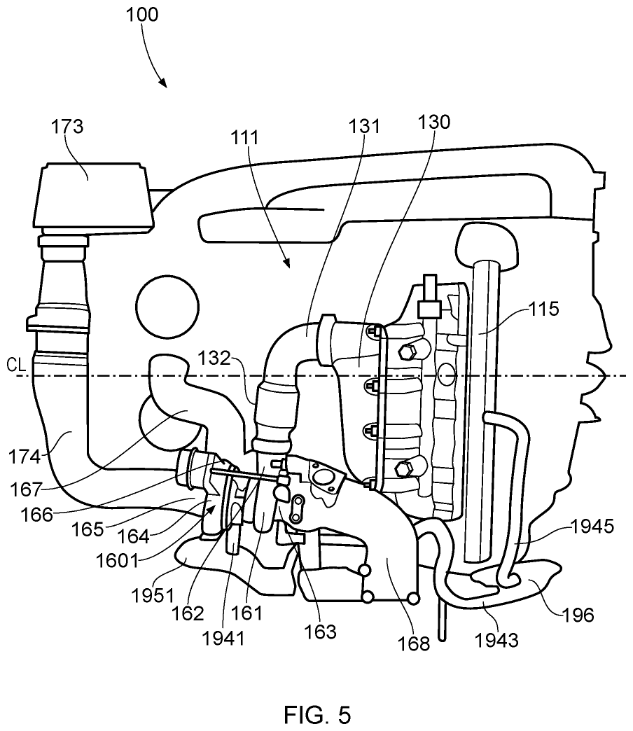

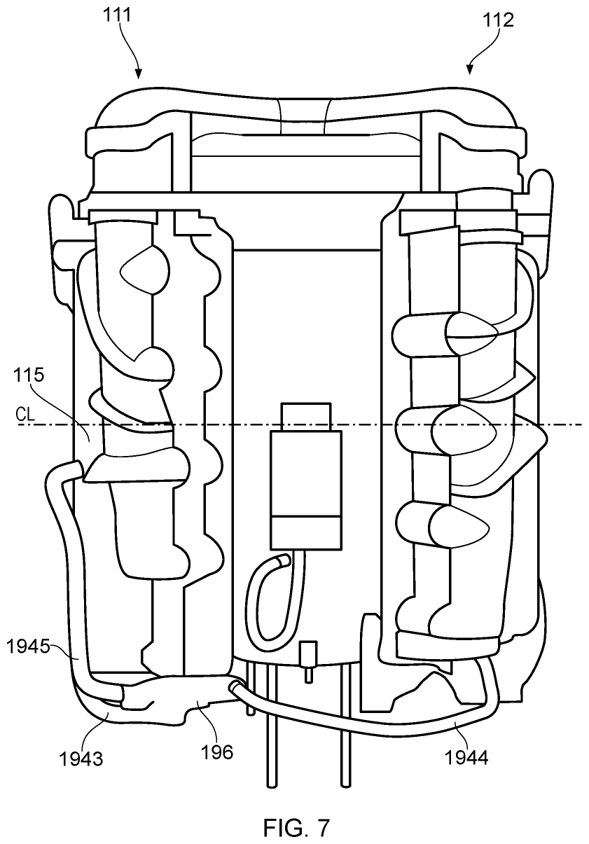

As shown in FIGS. 5 to 7, the first and second turbochargers 1601, 1602 are mounted on the outer sides of the first and second cylinder banks 111, 112 at a position below the horizontal centre line CL of the engine 100 and towards the crankcase end of the engine block. Each of the first and second cylinder banks 111, 112 comprises an exhaust manifold 130, and an exhaust manifold ducting 131 along which a thermal expansion joint 132 is provided. The first and second turbochargers 1601, 1602 each have a turbine housing 161 with a turbine inlet 162 and a turbine outlet 163, and a compressor housing 164 with a compressor inlet 165 and a compressor outlet 166. The compressor inlet 165 of each of the turbochargers 1601, 1602 is connected to an air filter 173 via an air inlet duct 174. The compressor outlet 166 of each of the turbochargers 1601, 1602 is connected to the air intake manifold via charge ducting 167. In the illustrated embodiment, the charge ducting 167 is provided as a flexible hose. In this way, filtered air is able to flow into the compressor 164 so as to be compressed therein prior to entering the cylinders. Following combustion in the cylinders within the engine block 110, exhaust gases pass to the exhaust manifold 130 of each cylinder bank and are delivered to the turbine inlet 162 of each turbocharger 1601, 1602. In this way, the exhaust gas expelled from the engine block 110 is used to drive a turbine and compressor of the turbochargers. The exhaust gas then flows out of the turbine housing 161 of each turbocharger via a turbocharger exhaust conduit 168 so as to be directed to the one or more gas outlets of the outboard motor.

As best seen in FIG. 5, the first drain tank 1951 is mounted below the first turbocharger 1601 and is connected to a lubricating fluid outlet of the first turbocharger 1601 by a first turbo drain duct 1941. In this example, the first drain tank 1951 is directly adjacent to the first turbocharger 1601 and the first turbo drain duct 1941 is a short length of hose. In other examples, the first drain tank 1951 may be remote from the first turbocharger, for example separated from the first turbocharger by one or more intermediate components of the engine. In such examples, the first turbo drain duct 1941 may be longer and routed around the intermediate components of the engine.

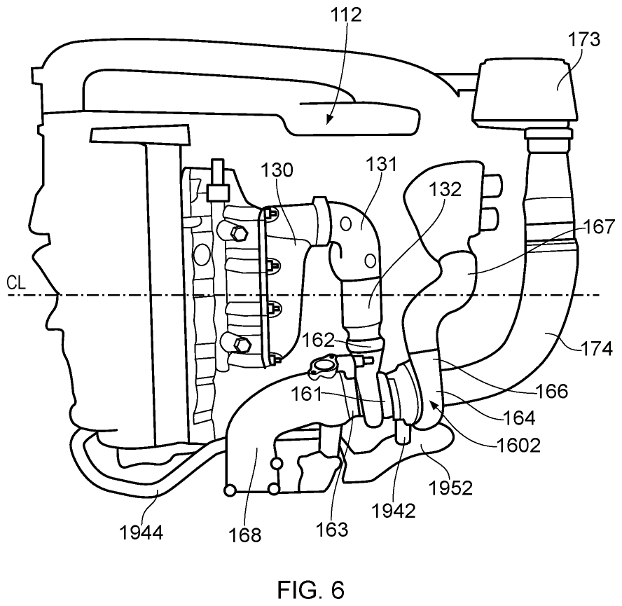

As best seen in FIG. 6, in a similar manner, the second drain tank 1952 is mounted below the second turbocharger 1602 on the opposite side of the engine 100 to the first drain tank 1951 and is connected to the lubricating fluid outlet 193 of the second turbocharger 1602 by a second turbo drain duct 1942. As with the first drain tank 1951, in this example, the second drain tank 1952 is directly adjacent to the second turbocharger 1602 and so the second turbo drain duct 1942 is a short length of hose, but in other examples the second drain tank may be remote from the second turbocharger and the second turbo drain duct may be longer and routed around one or more intermediate components of the engine.

The scavenge pump 196 is mounted at a position below the horizontal centre line CL of the engine 100 and towards the cam cover end of the engine block. The upstream side of the scavenge pump 196 is connected to the first drain tank 1951 by a first drain tank duct 1943 and is connected to the second drain tank 1952 by a second drain tank duct 1944. The downstream side of the scavenge pump 196 is connected to the engine block by a scavenge pump outlet duct 1945. In this example, the scavenge pump 196 is mounted to an under surface of the first cylinder bank 111 adjacent to the cam cover 115 of the first cylinder bank 111. The scavenge pump outlet duct 1945 extends from the scavenge pump 196 to the cam cover 115 of the first cylinder bank 111 at a position towards the horizontal centre line CL of the engine.

The scavenge pump 196 is a mechanical pump which is configured to be driven by a camshaft (not shown) of the first cylinder bank 111. In the position shown, the scavenge pump may be driven directly by the camshaft. In other examples, the scavenge pump 196 may be mounted in a different position, such as under the second cylinder bank 112, or between the first and second cylinder banks 111, 112. The scavenge pump may be driven directly by a different shaft of the engine, such as a camshaft of the second cylinder bank 112, or indirectly such as via a belt or chain.

During operation, lubricating fluid is delivered to each of the first and second turbochargers 1601, 1602 via their respective lubricating fluid inlets 192. The lubricating fluid lubricates various moving components within each turbocharger, such as bearing surfaces of the rotor shaft and of the turbine and compressor wheels, before draining from the turbocharger through its lubricating fluid outlet 193. Lubricating fluid drained from the first turbocharger 1601 is delivered by the first turbo drain duct 1941 to the first drain tank 1951. Lubricating fluid drained from the second turbocharger 1602 is delivered by the second turbo drain duct 1942 to the second drain tank 1952. Lubricating fluid is then drained from the first and second drain tanks 1951 and 1952 by the scavenge pump 196 via the drain tank ducts 1943, 1944 and returned to the engine block 110 via the scavenge pump outlet duct 1945. In this manner, lubricating fluid is readily drained from the turbochargers during operation and adequate lubricating fluid flow through the turbochargers may be more readily maintained, even when the outboard motor is subjected to extreme operating angles.

Due to the presence of the drain tanks 1951, 1952, lubricating fluid will continue to drain from the turbochargers even after engine shutdown, when the scavenge pump is no longer pumping. Further, the drain tanks provide a volume into which lubricating fluid in the drain line flow back to following engine shutdown to avoid backflow of that lubricating fluid into the turbochargers. Both of these aspects reduce the amount of lubricating fluid which remains in the turbochargers following engine shutdown and thereby reduce the extent to which lubricating fluid can migrate into one or both of the turbine and compressor housings following engine shutdown, when lubricant seals within the turbocharger are no longer energised. This reduces the risk of additional emissions on start-up, elevated lubricant consumption, and turbocharger durability issues. The provision of the drain tanks can also avoid the need for the scavenge pump to have its own backflow prevention means to prevent lubricating fluid from entering the turbochargers from the scavenge pump outlet line. This can facilitate reduced complexity of the scavenge pump.

Although the invention has been described above with reference to one or more preferred embodiments, it will be appreciated that various changes or modifications may be made without departing from the scope of the invention as defined in the appended claims.

For example, although the scavenge pump is described as a mechanical pump driven off the intake camshaft of one bank, such a pump could be driven in a number of different ways including by any of the other camshafts or by an independent lay shaft driven off the crank or other dynamic component of the engine. Equally such a pump could be electrically driven which could enable more flexible location of the pump as well as engine speed independent pump speed leading to small fuel economy improvements. Additionally, whilst the scavenge pump is shown to discharge to the cam cover in this embodiment, it could discharge to other locations on the engine as long as the exit from the pump line is positioned in such a way as to ensure that it is not submerged in lubricant in a shutdown state.

1. A marine outboard motor having an internal combustion engine, the internal combustion engine comprising:
an engine block having an engine lubrication fluid circuit;
at least one turbocharger having at least one lubricating fluid inlet and at least one lubricating fluid outlet; and
a turbocharger lubrication system configured to lubricate the at least one turbocharger, the turbocharger lubrication system comprising a feed path extending from the engine lubrication fluid circuit to the at least one lubricating fluid inlet, and a drain path extending from the at least one lubricating fluid outlet to the engine block,
wherein the drain path comprises at least one drain tank configured to receive lubricating fluid drained from the at least one lubricating fluid outlet, and a scavenge pump configured to return lubricating fluid from the at least one drain tank back to the engine lubrication fluid circuit.

2. The marine outboard motor of claim 1, wherein the at least one turbocharger is positioned below a horizontal centre line of the engine block.

3. The marine outboard motor of claim 1, wherein the at least one drain tank is remote from the at least one turbocharger.

4. The marine outboard motor of claim 1, wherein the engine lubrication fluid circuit comprises a sump and wherein the drain path extends to a part of the engine block which is remote from the sump.

5. The marine outboard motor of claim 1, wherein the engine block comprises a cam cover and wherein the drain path extends to the cam cover so that, during use, the scavenge pump returns lubricating fluid to the engine lubrication fluid circuit via the cam cover.

6. The marine outboard motor of claim 1, wherein the scavenge pump is an electric pump.

7. The marine outboard motor of claim 1, wherein the scavenge pump is a mechanical pump which is configured to be driven by a shaft of the internal combustion engine.

8. The marine outboard motor of claim 7, wherein the shaft is a camshaft of the internal combustion engine.

9. The marine outboard motor of claim 1, wherein the at least one turbocharger comprises a plurality of turbochargers and wherein the at least one drain tank is configured to receive lubricating fluid drained from the at least one lubricating fluid outlet of each of the plurality of turbochargers.

10. The marine outboard motor of claim 1, wherein the at least one turbocharger comprises a plurality of turbochargers and wherein the at least one drain tank comprises a plurality of drain tanks configured to receive lubricating fluid drained from the at least one lubricating fluid outlet of the plurality of turbochargers.

11. The marine outboard motor of claim 1, wherein the engine block comprises a first cylinder bank and a second cylinder bank.

12. The marine outboard motor of claim 11, wherein the at least one turbocharger comprises a first turbocharger mounted on the first cylinder bank and a second turbocharger mounted on the second cylinder bank.

13. The marine outboard motor of claim 12, wherein the at least one drain tank comprises a first drain tank configured to receive lubricating fluid drained from the at least one lubricating fluid outlet of the first turbocharger, and a second drain tank configured to receive lubricating fluid drained from the at least one lubricating fluid outlet of the second turbocharger.

14. The marine outboard motor of claim 13, wherein the scavenge pump is a single scavenge pump configured to return lubricating fluid from both of the first and second drain tanks back to the engine lubrication fluid circuit.

15. The marine outboard motor of claim 1, wherein the internal combustion engine is a vertical axis internal combustion engine.

16. The marine outboard motor of claim 1, wherein the internal combustion engine is a diesel engine.

17. A marine vessel comprising the marine outboard motor of claim 1.
